(19) United States
(12) Patent Application Publication
(10) Pub. No.: US 2015/0341460 A1
(43) Pub. Date: Nov. 26, 2015

(54) System and Method for Pre-fetching

(71) Applicant: FUTUREWEI TECHNOLOGIES, INC., Plano, TX (US)

(72) Inventors: Vaishnav Kovvuri, Sunnyvale, CA (US); Jim Zhao, Los Altos, CA (US)

(73) Assignee: FUTUREWEI TECHNOLOGIES, INC., Plano, TX (US)

(21) Appl. No.: 14/285,204

(22) Filed: May 22, 2014

(51) Int. Cl. H04L 29/08

(52) U.S. Cl. CPC H04L 67/2847; H04L 67/10

(57) ABSTRACT

In one embodiment, a method for pre-fetching files includes parsing a project file to produce a parsed project file and extracting a plurality of files from the parsed project file to produce a file list. The method also includes retrieving, by a caching device from a file server over a network, the plurality of files in accordance with the file list and storing the plurality of files in a cache.

### TECHNICAL FIELD

The present invention relates to a system and method for cache management, and, in particular, to a system and method for pre-fetching.

### BACKGROUND

In today's enterprise world, there are geographically dispersed remote offices across the globe with a centralized headquarters and relatively few data centers. Data from the data centers may be shared around the globe across multiple remote offices over a wide area network (WAN). A WAN may be unreliable with limited bandwidth. Meanwhile, applications are becoming more bandwidth intensive, which indirectly creates performance issues for simple operations on files, such as reading and writing.

Applications use file sharing protocols. To improve performance when such protocols are used, intermediate caching devices are installed to cache the objects. Caches may be both read and write caches which cache the data for better user experience and provide better data consistency. Data caching is a mechanism for temporarily storing content on the edge side of the network to reduce bandwidth usage, server load, and perceived lag when that content is re-accessed by the user. Caching may be applied in a variety of different network implementations, such as in content distribution networks (CDNs), enterprise networks, internet service provider (ISP) networks, and others. Generally speaking, caching is performed by fetching content in response to a client accessing the content, storing the content in a cache for a period of time, and providing the content directly from the cache when the client attempts to re-access the content.

Protocols like common internet file system (CIFS) are chatty and perform multiple reads and writes of data. Also, protocols like hypertext transfer protocol (HTTP) bring in the same data over and over again when multiple users try to access the same data. Applications also perform multiple iterations of the same file operations (open, read, close). Caching devices work around this by performing data caching and pre-fetching. Pre-fetching of data may be initiated when a user expresses interest in opening or reading a file. The user may experience slowness if the data is changed in the back-end file server, because the changed data flows in the network. In another example, an administrator of the device manually pre-loads the data before the user accesses the data. However, this may be error prone and not deterministic.

### SUMMARY

An embodiment method for pre-fetching files includes parsing a project file to produce a parsed project file and extracting a plurality of files from the parsed project file to produce a file list. The method also includes retrieving, by a caching device from a file server over a network, the plurality of files in accordance with the file list and storing the plurality of files in a cache.

An embodiment method of opening files includes retrieving, by a caching device from a file server over a network, a plurality of files associated with a project file in a cache when a client initiates opening only the project file or a subset of the plurality of files and storing the plurality of files in a cache of the caching device. The method also includes receiving, by the caching device from a user, a file open request to open a first file, where the plurality of files includes the first file and reading the first file from the cache.

An embodiment caching device includes a processor and a computer readable storage medium storing programming for execution by the processor. The programming includes instructions to parse a project file to produce a parsed project file and extract a plurality of files from the parsed project file to produce a file list. The programming also includes instructions to retrieve, from a file server over a network, the plurality of files in accordance with the file list and store the plurality of files in a cache.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment network for pre-fetching;

FIG. 2 illustrates another embodiment network for pre-fetching;

FIG. 3 illustrates a message diagram for file caching;

FIGS. 4A-D illustrates embodiment container files;

FIG. 5 illustrates an embodiment system for pre-fetching;

FIG. 6 illustrates a flowchart for an embodiment method of pre-fetching;

FIG. 7 illustrates a flowchart for another embodiment method of pre-fetching; and

FIG. 8 illustrates a block diagram of an embodiment general-purpose computer system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Remote offices are located around the world. Data transferred from centralized servers is affected by latency and bandwidth limitation of wide area networks (WANs), which generally are slower than a local area network (LAN). It is desirable, however, for a WAN user to have a LAN like user experience.

To improve the quality of user experience, intermediate caching devices initiate a pre-fetching of the file when the user expresses interest in it by initiating a first read on the file. In general, pre-fetching is initiated after the file is opened or the first block is read. However, users tend to work on a logical group of files or data sets associated as a project. Each project contains a few to many files. If the files are grouped together, the user tends to open some of the associated files soon after opening one of the associated files.

Files which are logically grouped together may form a project file or a container file. Project files contain metadata about the location of the files and the names of the files. The format of the project files may be text based for Make files, extensible markup language (XML) based for applications such as Visual Studio or AutoCAD, or in any other format, such as a batch file. When a remote user accesses the project files across a WAN, he is likely to open more than one file in the project. Because most of the file specific information is available in the project file, an embodiment caching system incorporates an infrastructure which parses the project files and performs pre-fetching operations on the files and/or directories. Because there are many applications with various formats of project files, an infrastructure takes in multiple formats in the form of plug-ins, where different plug-ins handle different types of projects. These plug-ins parse the respective formats and extract lists of pathnames and directories. This information is provided to the pre-fetch engine, which perform the pre-fetch of the files before the user actually issues an open or read on one of the files. The plug-ins may be loaded into the cache engine via a common language infrastructure (CLI) or another means. The plug-in manager updates its database of available plug-ins directly so operations on the requested project file can be passed on to the correct plug-in. One example is application specific instead of protocol based. Applications such as AutoCAD, Eclipse, and Corel may be optimized differently even if they work on the same protocol across a WAN.

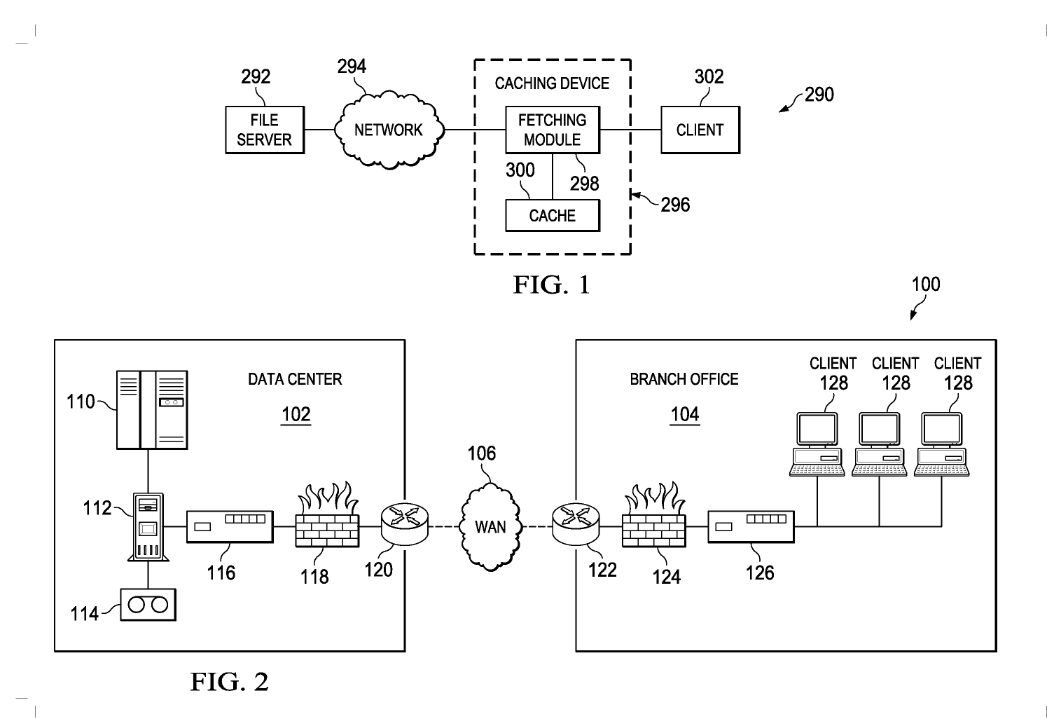

FIG. 1 illustrates network environment 290 which supports file pre-fetching. As shown, the network environment 290 includes file server 292, caching device 296, network 294, and client 302. File server 292 may be any component or collection of components configured to store files. File server 292 may be a remote server which stores files to be accessed by remote clients, such as client 302.

Network 294 may be a WAN, a LAN, or another type of network. Files on file server 292 are accessed by client 302 over network 294.

Caching device 296 may be any component or collection of components configured to fetch files from files server 292 on behalf of client 302, and to cache the file so that the file may be accessed by client 302. Caching device 296 may include fetching module 298 for fetching the files and cache 300 for storing the files. Files are downloaded across network 294 from file server 292. Fetching module 298 fetches files from file server to cache 300 over network 294, from file server 292 over network 294 to client 302, and from cache 300 to client 302.

Client 302 may correspond to any entity (e.g., an individual, office, company, etc.) or group of entities (e.g., subscriber group, etc.) that access files stored in file server 292. In embodiments provided herein, caching device 296 may pre-fetch files and/or file updates from file server 292 prior to the files being re-accessed by client 302, and store the pre-fetched files in cache 300. The files may be pre-fetched based on a project opened by client 302, and may be provided directly from cache 300 to client 302 upon being re-accessed by client 302.

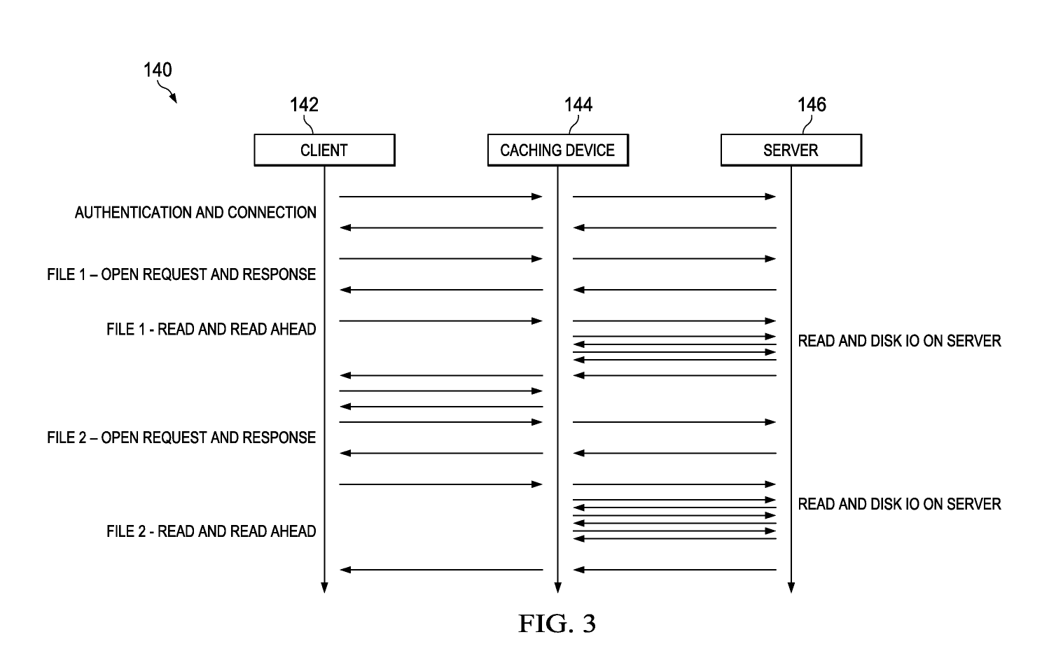

The embodiment pre-fetching techniques provided by this disclosure are applicable to any network environment in which files stored on one side of a network are cached on another side of the network, including content distributed networks (CDNs), enterprise networks, internet service provider (ISP) networks, wide area optimization networks, and others. FIG. 2 illustrates network environment 100 with a data center and a branch office which communicate over a WAN. Data center 102 is coupled to branch office 104 via WAN 106. Data center 102 contains file server 112, which may be a Windows or Unix file servers. File server 112 stores files which may be remotely accessed. Data is stored in storage 110 and tape backup 114 in data center 102.

WAN optimization (WANO) box 116 performs WAN optimization to increase the data efficiency across WAN 106. WANO techniques include optimization in throughput, bandwidth requirements, latency, protocol optimization, and congestion avoidance.

Firewall 118 protects the data center. Firewall 118 is a network security system which controls the incoming and outgoing network traffic.

Router 120 interacts between data center 102 and WAN 106, while router 122 interacts between WAN 106 and branch office 104. Routers 120 and 122 forward data packets between data center 102 and branch office 104.

WAN 106 is coupled to router 122 in branch office 104. Firewall 124 protects branch office 104. Firewall 124 controls incoming and outgoing network traffic to provide security for branch office 104.

The data is received by WANO box 126 and disseminated to clients 128. WANO box 126 performs optimization to improve efficiency across WAN 106. Also, WANO box 126 contains cache for storing data. WANO boxes 116 and 126 may be any devices configured to provide an interface to the WAN 106, and may include fetching modules and/or other components for performing the pre-fetching and optimization techniques provided by this disclosure.

More information on pre-fetching is discussed in U.S. patent application Ser. No. 14/231,508 filed on Mar. 14, 2014, and entitled “Intelligent File Pre-Fetch Based on Access Patterns,” which application is hereby incorporated herein by reference.

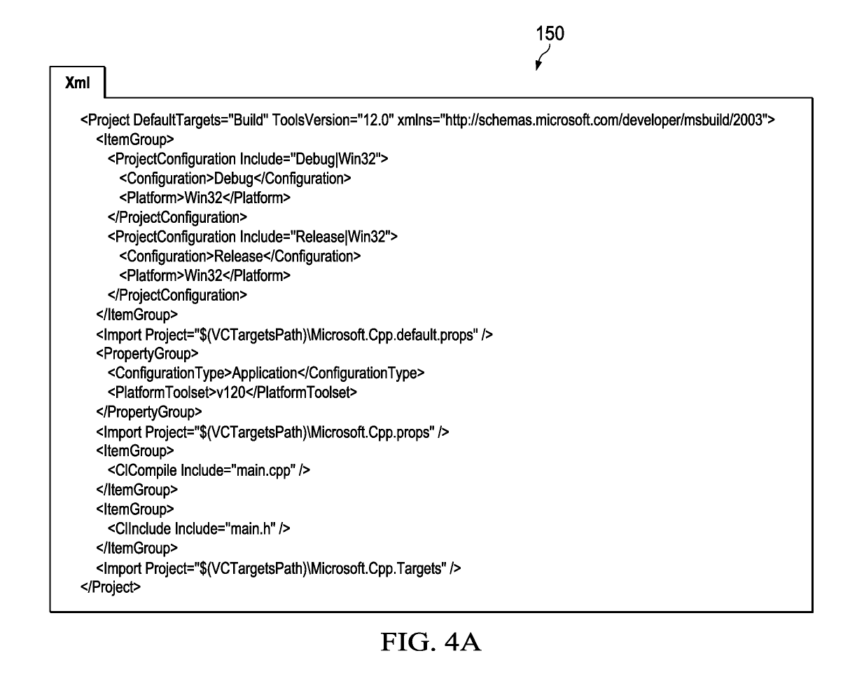

FIG. 3 illustrates message diagram 140 for read ahead caching of individual files. Read ahead caching is performed on a per-file basis, where individual files are cached. When there is a collection of files, for example a project, files are pre-fetched one at a time. With an embodiment, multiple files may be pre-fetched at a time. The process begins when the client attempts to access a file, which prompts the caching device to send a file request to the file server to fetch a version of the file. Client 142 sends an authentication and connection request to caching device 144. Caching device 144 either authenticates or forwards the authentication and connection request to server 146. In response, server 146 sends a response to caching device 144, which caching device 144 forwards to client 142.

Next, client 142 opens File 1 and requests to open the file. This request is sent to caching device 144 and passed on to server 146. Server 146 responds to caching device 144, and the response is sent to client 142. The file is then open.

Caching device 144 requests to read and read ahead from server 146 for file 1. Reading and disk input/output (IO) are performed on server 146 and the data is sent to caching device 144. Caching device 144 sends the read data to client 142. Also, caching device 144 pre-fetches on behalf of client 142 and performs read ahead.

Client 142 reopens and requests a response for file 2. As with file 1, Client 142 receives data for read and read ahead for file 2. This request is sent to caching device 144 and passed on to server 146. Server 146 responds to caching device 144, and the response is sent to client 142. The file is then open.

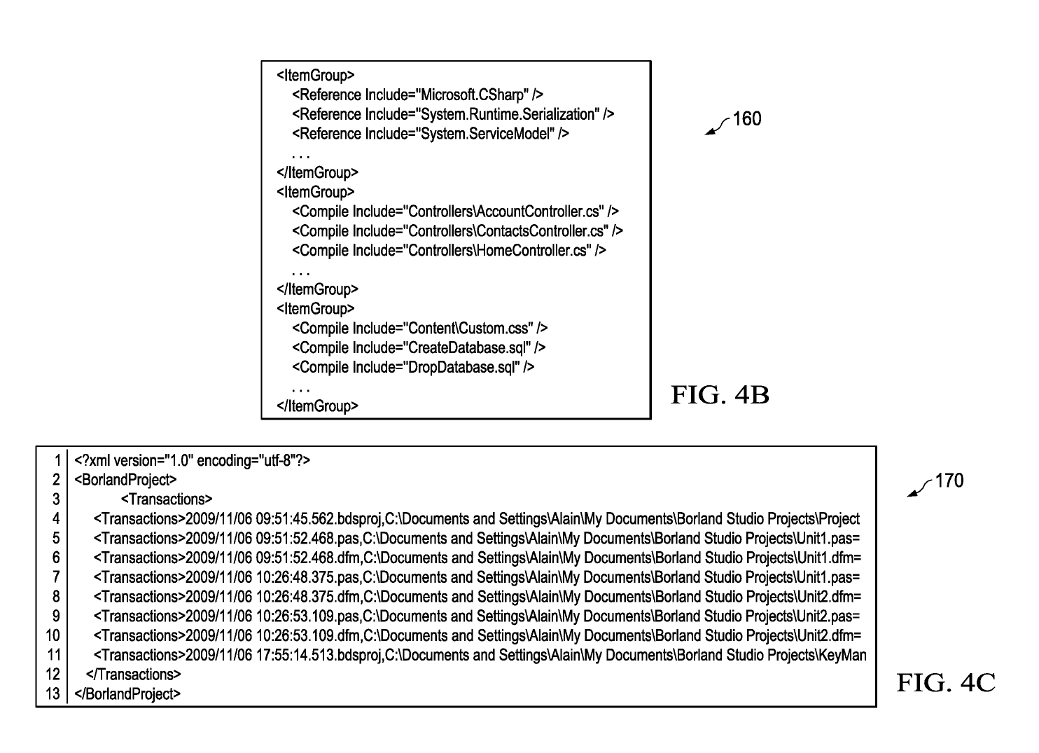

Often, files are logically grouped together in a collection of files as project files or container files. The project or container files contain the names and locations of the files in the project. Some examples of project or container files are .NET project files (.vcxproj), Eclipse project files (.project), Rstudio (.rproj), Qt project file (.pro), AutoCAD project file (.wdp, .wdd), Unix/Linus Makefile, A4desk (.a4p), Adobe device (.adcp), Anjuta integrated developer environment (IDE) (anjuta), Borland developer studio (.bdsproj), C# project file (.scproj), and Delphi Project (.dproj). FIGS. 4A-D illustrates some example project files. FIG. 4A illustrates .NET project file 150, FIG. 4B illustrates C# project file 160, FIG. 4C illustrates Borland project file 170, and FIG. 4D illustrates Makefile 180.

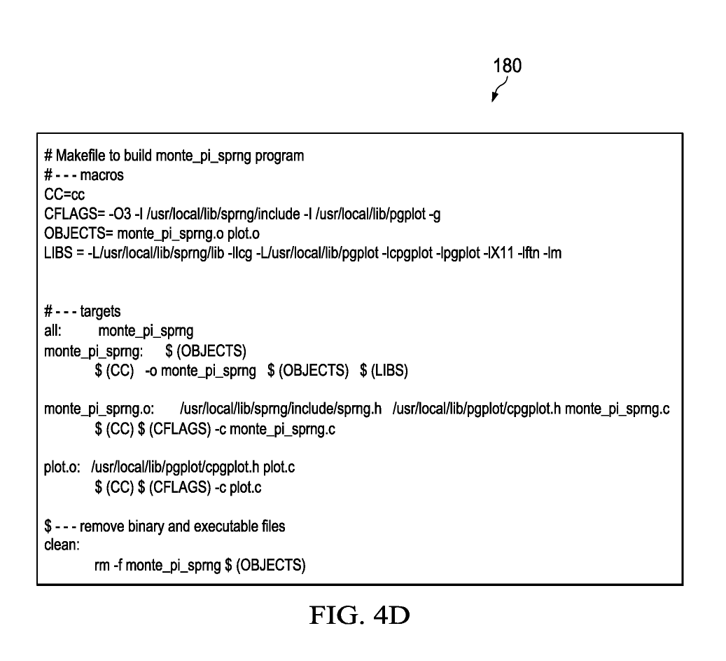

FIG. 5 illustrates system 190 for pre-fetching project files. The files are pre-fetched when a container file is opened, or one of the member files of a container file is opened. System 190 detects a collection of files, and caches all the files in the associated project files. When a user requests to open a project file, open module 200 receives this request, and passes it on to plug-in manager 202. The request may be to open a project file, a file associated with a project file, or a file not associated with a project file. In one example, the file is already stored in cache. Alternatively, the file is not stored in cache.

Plug-in manager 202 manages plug-ins 192. Plug-in manager 202 is the master for plug-ins 192 and determines whether a file to be read is a recognized project file, associated with a recognized plug-in, or neither. The type of plug-in for the format of the project file is determined, for example, based on a proprietary file format. When the file is a project file or a part of a project file, plug-in manager 202 passes the request to the correct plug-in, which parses the corresponding project file. The plug-in has a parser for the appropriate container file, and extracts the file to be fetched. The plug-in extracts the information from the project file, parses the information, prepares a list of complete file names, and passes it on to the plug-in manager.

The list of files is then passed to pre-fetch module 208. The files are fetched and saved in cache. These files are pre-fetched and stored by cache module 212 in cache 214, local persistent cache. The files are retrieved from remote server 204 over WAN 206 to be stored in cache 214. The files are stored in local persistent cache 214.

When a user requests to read one of these files, read module 210 retrieves the files from cache module 212. If the file is stored in cache 214 in a current version, cache module 212 reads the file from cache 214 and passes the data to read module 210, which provides a fast response. When the current version of the file is not stored in cache, it may be downloaded over the network from the remote server.

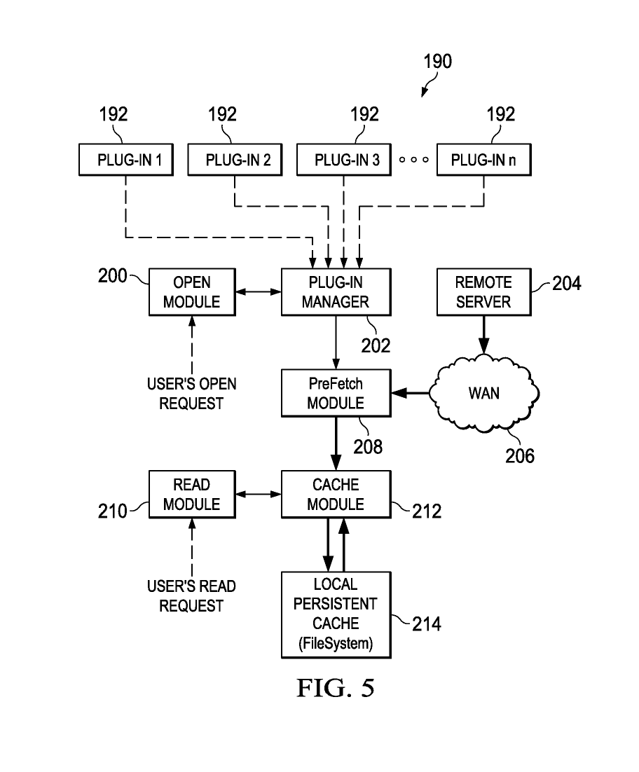

FIG. 6 illustrates flowchart 220 for a method of pre-fetching project files. Initially, in step 222, a user initiates a file open. For example, the user opens a file stored on a remote server. The file may be a project file, a part of a project file, or a file not associated with a project file.

Next, in step 224, the open information is duplicated and sent to a plug-in manager. The open information is sent to the plug-in manager to open the file and other files in the project file.

Then, in step 226, the plug-in manager performs validation. The plug-in manager determines whether the plug-in is a project file or a part of a project file. When the file to be opened is not a part of a project file, only the file is opened. When the file to be opened is a project file or a part of a project file, the files in the project file are pre-fetched, because the user is likely to open them in the future. The plug-in manager determines the appropriate plug-in to open the files.

In step 228, the plug-in manager determines if the appropriate plug-in is available. The plug-in manager may download, update, or delete a plug-in to obtain the appropriate plug-in. When the appropriate plug-in is not available, the system does nothing in step 230. When the plug-in is available, the plug-in parses the project file in step 232.

After the project file is parsed, a list of files to be pre-fetched is extracted by the plug-in in step 234. In one example, all of the files in the project file are pre-fetched. Alternatively, only a portion of the files are pre-fetched.

Next, in step 236, the project files are pre-fetched by the pre-fetch module. The files from the list determined in step 234 are pre-fetched and stored in persistent cache 238. The files may later be accessed from the cache.

When the user later wants to open a file, the files may be quickly read from persistent cache 238. To read a file which is already stored in cache, the user initiates a read of file 1 in step 240.

A read module verifies that the latest copy of the file is stored in cache 238 in step 242. There may be an older version of the file in the cache which is not the most current version. For example, a new version of the file may be updated on the remote server, but this new version has not yet been downloaded to the cache. Then, in step 244, it determines whether the local copy in cache is the latest version. When the latest copy is not stored in the cache, for example when the file has been updated, or if it was never pre-fetched, the system reads the file in step 248. The file is read across the WAN in step 250. This may lead to a delay.

When the latest copy is stored in cache, the system reads the file, in step 246, from persistent cache 238. This may be performed quickly.

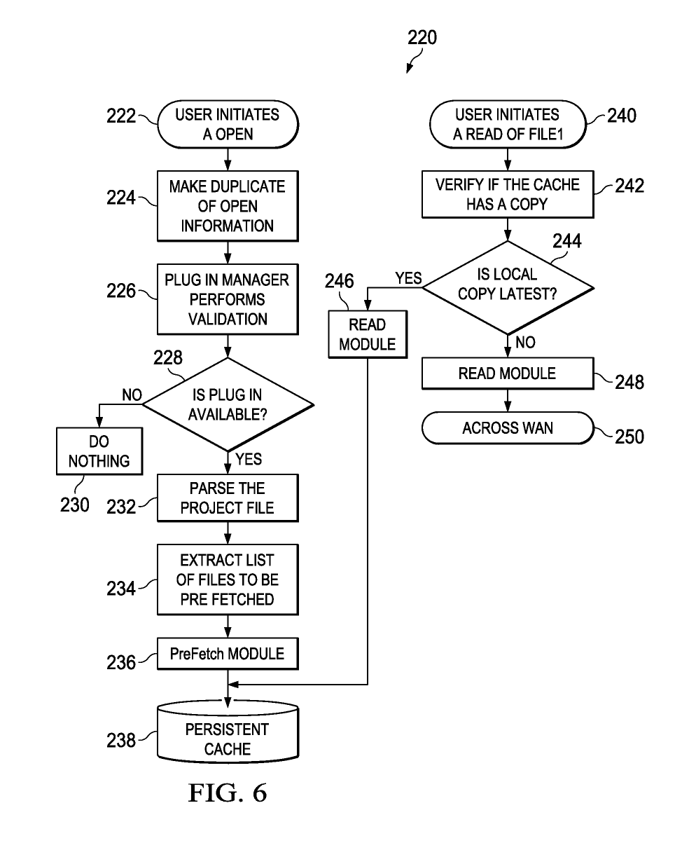

FIG. 7 illustrates flowchart 310 for a method of pre-fetching files. Initially, in step 340, a user initiates opening a file.

In step 316, the caching device determines whether the file is a container file. This may be done by determining whether the file is a proprietary container file. When the file is a part of a project file, the project file may be accessed. When the file is not a project file or a part of a project file, the caching device proceeds to step 314. When the file is a part of a project file or is a project file the caching device proceeds to step 318.

In step 314, the caching device determines whether the file is already in cache. When the file is already in the cache, the system proceeds to step 326. On the other hand, when the file is not stored in the cache, the system proceeds to step 324.

The caching device fetches a single file over a network in step 324. The network may be a WAN, or another network. The single file is read in over the network from a remote server. Also, the file is saved in cache for later access.

In step 326, the caching device determines whether the version of the file in the cache is the latest version of the file. When the version of the file in the cache is the latest version of the file, the system reads the file from the cache in step 328. When the version of the file in the cache is not the latest version of the file, the system fetches the file over the network in step 324. In this case, the file is opened with some delay. The file is also stored in the cache for later access.

In step 318, the caching device determines an appropriate plug-in for the project file, and that the plug-in is available. The plug-in manager examines the container file, and determines whether an appropriate plug-in is available. It may add a new plug-in, update an existing plug-in, or delete a plug-in as necessary. When the plug-in is not available, the system does not pre-fetch the project files in step 330. When the appropriate plug-in is available, the system proceeds to step 320.

In step 320, the caching device extracts the files from the container file. The container file is parsed and the files are extracted to create a list of files. The list may contain the name of the files and their locations.

Finally, in step 322, the files are pre-fetched over the network. At a later time, when the user initiates a read of one of the files in the container file, it may be quickly read from cache.

As used herein, the term “pre-fetching the file” refers to the action of fetching an electronic file without being prompted to do so by a client attempting to access the electronic file. Moreover, the term “file” is used loosely to refer to any object (e.g., file content) having a common characteristic or classification, and therefore the phrase “pre-fetching the file” should not be interpreted as implying that the electronic file being fetched is identical to “the [electronic] file” that was previously accessed by the client. For example, the file being pre-fetched may be an updated version of an electronic file that was previously accessed by the client. As another example, the file being pre-fetched may be a new instance of a recurring electronic file type that was previously accessed by the client, e.g., a periodic earnings report, an agenda, etc. In such an example, the client may not have accessed any version of the electronic file being pre-fetched. To illustrate the concept, assume the client is a newspaper editor that edits a final draft of the Tuesday's Sports Section, and that the caching device pre-fetches an electronic version of a final draft of Wednesday's Sport Section. The phrase “prefetching the file” should be interpreted to encompass such a situation even though the content of Wednesday's Sports Section differs from that of Tuesday's Sports Section, as (in this instance) “the file” refers to a type or classification associated with Tuesday's and Wednesday's Sports Section, rather than the specific content of Tuesday's Sports Section.

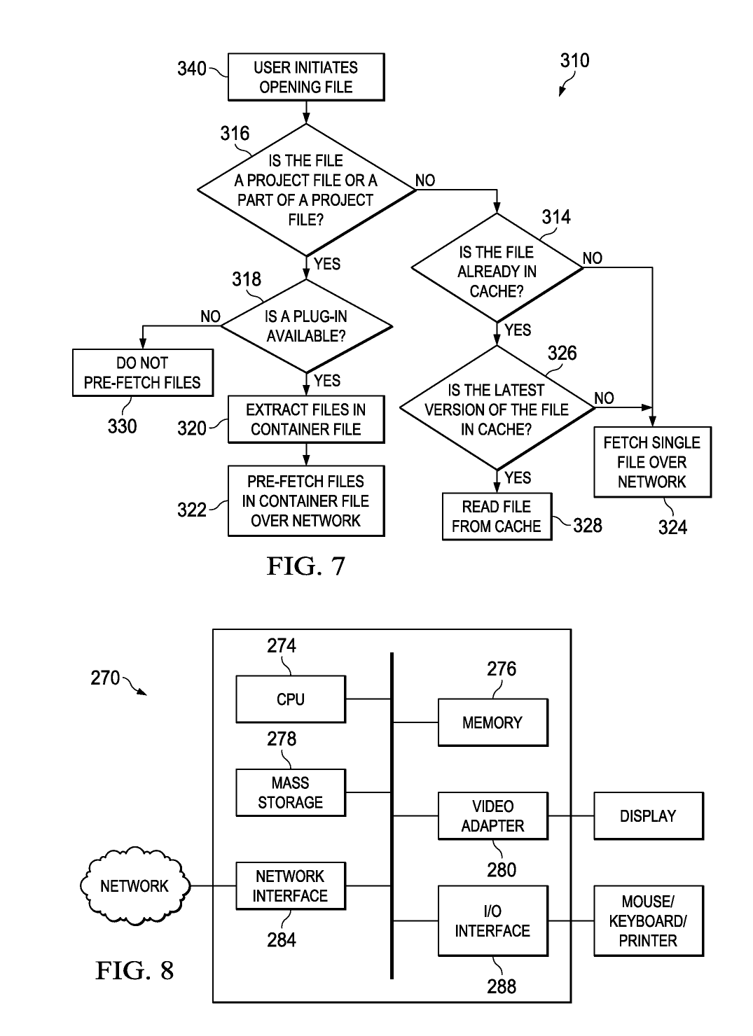

FIG. 8 illustrates a block diagram of processing system 270 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input devices, such as a microphone, mouse, touchscreen, keypad, keyboard, and the like. Also, processing system 270 may be equipped with one or more output devices, such as a speaker, a printer, a display, and the like. The processing unit may include central processing unit (CPU) 274, memory 276, mass storage device 278, video adapter 280, and I/O interface 288 connected to a bus.

The bus may be one or more of any type of several bus architectures including a memory bus or memory controller, a peripheral bus, video bus, or the like. CPU 274 may comprise any type of electronic data processor. Memory 276 may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

Mass storage device 278 may comprise any type of storage device configured to store data, programs, and other information and to make the data, programs, and other information accessible via the bus. Mass storage device 278 may comprise, for example, one or more of a solid state drive, hard disk drive, a magnetic disk drive, an optical disk drive, or the like.

Video adaptor 280 and I/O interface 288 provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not pictured) may be used to provide a serial interface for a printer.

The processing unit also includes one or more network interface 284, which may comprise wired links, such as an Ethernet cable or the like, and/or wireless links to access nodes or different networks. Network interface 284 allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for pre-fetching files, the method comprising:
parsing a project file to produce a parsed project file;
extracting a plurality of files from the parsed project file to produce a file list;
retrieving, by a caching device from a file server over a network, the plurality of files in accordance with the file list; and
storing the plurality of files in a cache.

2. The method of claim 1, wherein the project file is an extensible markup language (XML) file.

3. The method of claim 1, wherein the project file is a text file.

4. The method of claim 1, wherein the network is a wide area network (WAN).

5. The method of claim 1, wherein extracting the plurality of files is performed by a plug-in.

6. The method of claim 5, further comprising:
identifying the plug-in in accordance with a type of the project; and
determining whether the plug-in is available.

7. The method of claim 6, further comprising updating the plug-in when the plug-in is not available or a newer version of the plug-in is available.

8. The method of claim 6, further comprising downloading the plug-in when the plug-in is not available or a newer version of the plug-in is available.

9. The method of claim 1, further comprising receiving, by the caching device from a user, a file open request to open the project file.

10. The method of claim 1, further comprising receiving, by the caching device from a user, a file open request to open a first file associated with the project file.

11. The method of claim 1, further comprising receiving, by the caching device from a user, a file open request to open a first file of the project file after storing the plurality of files in the cache.

12. The method of claim 11, further comprising determining whether a version of the first file is stored in the cache.

13. The method of claim 12, further comprising determining whether the version of the first file is a current version.

14. The method of claim 13, further comprising reading the version of the first file from the cache when the version of the first file is the current version.

15. The method of claim 13, further comprising retrieving, by the caching device from the file server over the network, the first file when the version of the first file is not the current version.

16. A method of opening files, the method comprising:
retrieving, by a caching device from a file server over a network, a plurality of files associated with a project file in a cache when a client initiates opening only the project file or a subset of the plurality of files;
storing the plurality of files in a cache of the caching device;
receiving, by the caching device from a user, a file open request to open a first file, wherein the plurality of files comprises the first file; and
reading the first file from the cache.

17. The method of claim 16, further comprising determining whether a version of the first file in the cache is a current version, wherein reading the first file from the cache is performed when the version of the first file in the cache is the current version.

18. The method of claim 17, further comprising:
retrieving, by the caching device from the file server over the network, the first file when the version of the first file in the cache is not the current version; and
storing the first file in the cache.

19. A caching device comprising:
a processor; and
a computer readable storage medium storing programming for execution by the processor, the programming including instructions to
parse a project file to produce a parsed project file,
extract a plurality of files from the parsed project file to produce a file list,
retrieve, from a file server over a network, the plurality of files in accordance with the file list, and
store the plurality of files in a cache.

20. A caching device comprising:
a processor; and
a computer readable storage medium storing programming for execution by the processor, the programming including instructions to
store a plurality of files associated with a project file in cache when a client initiates opening only the project file or a subset of the plurality of files,
receive, from a user, a file open request to open a first file, wherein the plurality of files comprises the first file, and
read the first file from the cache.
